(19) United States
(12) Patent Application Publication
(10) Pub. No.: US 2026/0080262 A1
(43) Pub. Date: Mar. 19, 2026

(54) ACCELERATING LOCAL TRAINING AND ACHIEVING A HIGHLY ACCURATE GLOBAL MODEL FOR FEDERATED LEARNING (FL)

(71) Applicant: Rakuten Mobile, Inc., Tokyo (JP)

(72) Inventors: Di WU, St Andrews (GB); Jee Chang, Leon WONG, Setagaya-ku, Tokyo (JP); Blesson VARGHESE, St Andrews (GB)

(21) Appl. No.: 18/749,521

(22) Filed: Jun. 20, 2024

(51) Int. Cl. G06N 3/098

(52) U.S. Cl. CPC G06N 3/098

(57) ABSTRACT

Global gradients of a global model from a server are received at a plurality of device. Aggressive regularization-based layer freezing is applied at the plurality of devices to the global gradients to identify local layers to freeze in a local model. Based on the local layers identified to freeze, a local state list of the local model is produced. Local gradients produced by the plurality of devices are received at the server. Global gradients are created at the server based on the local gradients. Conservative convergence-based layer freezing is applied at the server to produce a list of frozen layers of the global model based on the global gradients. The list of frozen layers of the global model are provided to the plurality of devices for producing the local state list.

### FIELD

The present disclosure relates to accelerating local training and achieving a highly accurate global model for Federated Learning (FL).

### BACKGROUND

Federated Learning (FL) enables privacy-preserving and collaborative machine learning on edge devices. In FL, the models are usually trained on local devices and a server supports the aggregation of models obtained from the devices after each training round. Consequently, edge devices with limited resources incur a substantial computation overhead that results in impractical training latencies.

To reduce the device-side computation overhead, various approaches have been integrated into FL. Examples include pruning, partial training, and offloading.

These approaches assume that parameters in the model need to be trained with the same workload. However, recent research has demonstrated that different layers in neural networks use varying numbers of training rounds to converge. Building upon this observation, layer freezing has been proposed as a useful technique for reducing oversupplied computation costs. The amount of computation on a device side is reduced by freezing specific layers of a neural network during training because calculation of the gradients for those layers is eliminated.

Existing layer freezing techniques can be categorized as early-stage layer freezing and accuracy-guaranteed layer freezing, based on when the layers are frozen. Early-stage layer freezing starts to freeze layers from the initial stages of training to achieve significant acceleration. In an extreme variant of early-stage layer freezing, also known as transfer learning, layers are frozen and initialized with pre-trained weights before training begins. For accuracy-guaranteed layer freezing, the convergence behavior of the layers is monitored during training, and a layer is frozen if it has converged.

However, existing state-of-the-art layer freezing approaches cannot balance high accuracy and acceleration, making them ineffective to apply in Federated Learning (FL). Specifically, early-stage layer freezing techniques accelerate training but achieve a lower final accuracy. On the other hand, accuracy-guaranteed layer freezing techniques obtain a higher final accuracy but with marginal training time improvement.

Early-stage layer freezing significantly reduces the computational burden on resource-constrained devices by aggressively eliminating the updates of layers even at the early rounds of training. However, this often leads to a substantial accuracy loss, specifically when a large number of layers are prematurely frozen. Therefore, pre-trained weight initialization is usually used for early-stage layer freezing to reduce accuracy loss. Nonetheless, there is still a significant loss in accuracy if there is a domain shift between the pre-training dataset and the target dataset.

Accuracy-guaranteed layer freezing achieves a high accuracy by freezing layers that have converged. However, layer convergence typically occurs and can be detected at the end of training, which often results in inefficient computational performance.

### SUMMARY

In some embodiments, a method includes receiving, at a plurality of devices, global gradients of a global model from a server. Aggressive regularization-based layer freezing is applied at the plurality of devices to the global gradients to identify local layers to freeze in a local model. Based on the local layers identified to freeze, a local state list of the local model is produced. Local gradients produced by the plurality of devices are received at the server. Global gradients are created at the server based on the local gradients. Conservative convergence-based layer freezing is applied at the server to produce a list of frozen layers of the global model based on the global gradients. The list of frozen layers of the global model are provided to the plurality of devices for producing the local state list.

In some embodiments, a device is configured to receive global gradients of a global model from a server. Local training gradients are generated based on the global gradients of the global model received from the server and a local state list. Aggressive regularization-based layer freezing is applied to the local training gradients to identify local layers to freeze in a local model. Based on the local layers identified to freeze, the local state list of the local model is produced.

In some embodiments, a non-transitory computer-readable media having computer-readable instructions stored thereon, which when executed performs operations to receive local gradients from a plurality of devices. The local gradients from the plurality of devices are aggregated to produce updated global gradients. The updated global gradients are provided to the plurality of devices. Conservative convergence-based layer freezing is applied to the updated global gradients to produce a list of frozen layers of the global model. The list of frozen layers of the global model are provided to the plurality of devices for producing a local state list.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIGS. 1a-b illustrate accuracy of FL training using early-stage layer freezing approaches according to at least one embodiment.

FIG. 2a shows the test accuracy for different rounds in FL training with accuracy-guaranteed layer freezing for VGG11 on CIFAR-10.

FIG. 2b show the latency incurred for a target accuracy in FL training with accuracy-guaranteed layer freezing for VGG11 on CIFAR-10.

FIGS. 3a-b are plots of the Singular Vector Canonical Correlation Analysis (SVCCA) Score of each VGG11 layer during FL training.

FIG. 4 is a block diagram of a system that provides an efficient layer freezing framework for FL according to at least one embodiment.

FIGS. 5a-f show the test accuracy curves for 3 network structures, LeNet (lightweight CNN), VGG11 (plain CNN), and ResNet12 (residual CNN), that are trained using the three different datasets, FMNIST, CIFAR-10, and CIFAR-100 datasets, respectively.

FIGS. 6a-f show the global freezing decisions during the training of the three datasets and the three models with random and pre-trained initialization.

FIGS. 7a-f shows the local freezing decisions made by Parallel Device/Server Freeze Framework according to at least one embodiment during the training.

FIG. 8 is a flowchart 800 of a method for providing parallel local learning and synchronized global aggregation to produce an optimal mode according to at least one embodiment.

FIG. 9 is a high-level functional block diagram of a processor-based system according to at least one embodiment.

FIG. 10 is a high-level functional block diagram of a processor-based system according to at least one embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

A method according to at least one embodiment includes receiving, at a plurality of devices, global gradients of a global model from a server. Aggressive regularization-based layer freezing is applied at the plurality of devices to the global gradients to identify local layers to freeze in a local model. Based on the local layers identified to freeze, a local state list of the local model is produced. Local gradients produced by the plurality of devices are received at the server. Global gradients are created at the server based on the local gradients. Conservative convergence-based layer freezing is applied at the server to produce a list of frozen layers of the global model based on the global gradients. The list of frozen layers of the global model are provided to the plurality of devices for producing the local state list.

Embodiments described herein provide a method that provides one or more advantages. For example, a Parallel Device/Server Freeze Framework for FL combines features of both early-stage acceleration and accuracy-guaranteed layer freezing. The Parallel Device/Server Freeze Framework for FL applies a regularization-based layer freezing approach on the device to apply early-stage layer freezing during the initial stages of local training for achieving improved speed in training. The Parallel Device/Server Freeze Framework for FL also applies a convergence-based layer freezing approach to ensure that a high final accuracy of a global model is achieved.

A Parallel Device/Server Freeze Framework according to at least one embodiment provides layer freezing framework that learns quickly and effectively by facilitating both early-stage and accuracy-guaranteed layer freezing. The Parallel Device/Server Freeze Framework according to at least one embodiment implements a novel dual-step layer freezing strategy on devices and the server, i.e., a device-side freezing and server-side freezing strategy. The device-side freezing adopts aggressive freezing strategy to facilitate early-stage layer freezing during local training. Specifically, device-side freezing strategy according to at least one embodiment uses regularization-based layer freezing. Regularization-based layer freezing achieves outcomes similar to traditional parameter regularization but offers additional advantages of computational savings through early-stage layer freezing. The server-side freezing utilizes a conservative convergence-based layer freezing accuracy-guaranteed layer freezing freezes layers when they are determined to have converged to ensure high accuracy of the global model. By combining device-side freezing and server-side freezing, the Parallel Device/Server Freeze Framework according to at least one embodiment achieves both acceleration and high accuracy layer freezing for FL.

In FL, training data is distributed across M devices, and in each round of FL training, K devices (K≤M) participate in training with their respective datasets

$$𝒟 := {𝒟}_{{k}_{k = 1}}^{K} .$$

The goal of FL is to optimize the following:

$$\begin{matrix}{min}_{θ} ℱ ( θ ) = {\sum }_{k = 1}^{K} \frac{{𝒟}_{k}}{𝒟} {F}_{k} ( θ ) \\ s . t . ℱ ( θ ) = \frac{1}{\vert {𝒟}_{k} \vert} {\sum }_{{ς}^{t} \sim {𝒟}_{k}} {ℱ}_{k} ( θ ; {ς}^{t} )\end{matrix} \qquad ( 1 )$$

where θ is the model parameters; F is the objective function on the server; [symbol] k is the objective function on device k (e.g., cross entropy loss [16]); ζt is a sampled mini-batch of data from [symbol] k at iteration t.

FL in a round r can be divided into two steps: local learning and global aggregation. For each device k, the learned parameters θₖ^{r} are optimized from the initial parameters θr−1 using a stochastic gradient descent (SGD) algorithm, namely local learning.

$${θ}_{k}^{r} - {arg min}_{0 \leq x \leq 1} {ℱ}_{k} ( θ ) \qquad ( 2 )$$

Thereafter, global aggregation is executed on the server:

$${θ}^{r} = {\sum }_{k = 1}^{K} \frac{{𝒟}_{k}}{\vert 𝒟 \vert} {θ}_{k}^{r} \qquad ( 3 )$$

Local learning and global aggregation are repeated for multiple rounds until the global model (θ) converges or achieves the desired accuracy.

One method for solving Equation 2 is to employ the minibatch gradient descent algorithm that updates the model parameters with a mini-batch gradient using:

$${θ}_{k}^{r} = {θ}_{k}^{r - 1} - γ ∇ {ℱ}_{k} ( {θ}_{k}^{r - 1} ) \qquad ( 4 )$$

with learning rate γ. By integrating Equation 1 to Equation 4, we derive the update rule for the global model as:

$$∇ ℱ ( {θ}^{r - 1} ) = {\sum }_{k = 1}^{K} \frac{{𝒟}_{k}}{\vert 𝒟 \vert} ∇ {ℱ}_{k} ( {θ}_{k}^{r - 1} ) \qquad ( 5 )$$

where ∇ [symbol] is the gradient on device k and ∇ [symbol] is the aggregated gradient on the server. To freeze parameters of the global model θ, a mask [symbol] ∈{0, 1}|θ| with the same size as θ is applied to the global gradient ∇ [symbol] (θ^{r-1}). This results in the following update rule:

$${θ}^{r} = {θ}^{r - 1} - γ ( ℳ ⊙ ∇ ℱ ( {θ}^{r - 1} ) \qquad ( 6 )$$

where ⊙ denotes the entry-wise (Hadamard) product. [symbol] is referred to as the parameter freezing matrix.

For Layer freezing, the sparsity in [symbol] can either be structured or unstructured. Hence, either structured or unstructured parameter freezing techniques can be used. In practice, structured layer freezing with regular sparsity at the layer has more computation and communication benefits than unstructured freezing. This is because structured layer freezing can reduce computation and communication costs of the frozen layer without requiring sparse optimization.

As mentioned, early-stage layer freezing has good training time acceleration but achieves a low final accuracy. On the other hand, accuracy-guaranteed layer freezing based on convergence analysis can guarantee higher final accuracy but with a marginal acceleration benefit. In addition, we identify the opportunity to achieve both early-stage and accuracy-guaranteed layer freezing by considering, for the first time, the application of both device side and server-side layer freezing within conventional FL.

When applying layer freezing techniques to improve FL training, existing methods of early-stage layer freezing and accuracy-guaranteed layer freezing are able to either reduce training time or achieve a high final accuracy. In other words, existing methods do not find a balance between improving accuracy and training time across different settings.

Early-stage layer freezing methods aggressively freeze the weights of certain layers of the DNN in the early rounds of training. Consequently, the weights of these layers are not adequately updated during training, resulting in a high loss of accuracy.

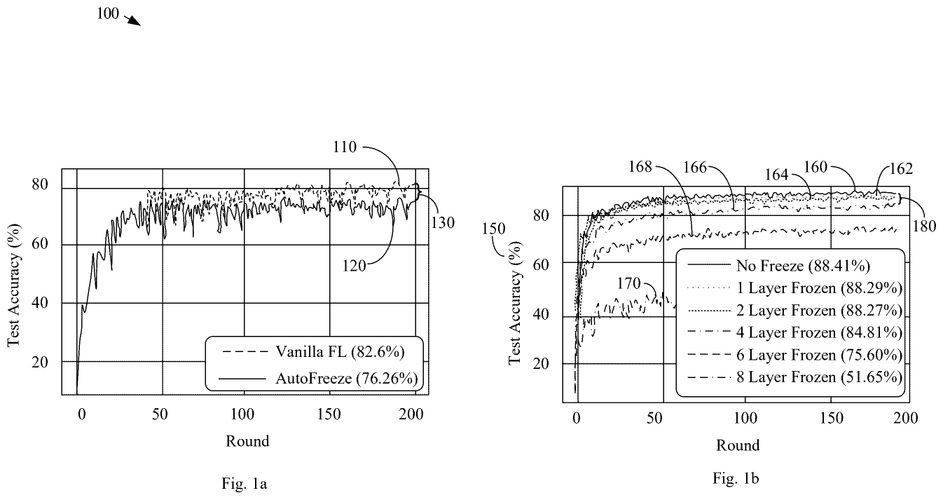

FIGS. 1a-b illustrate accuracy of FL training using early-stage layer freezing approaches 100 according to at least one embodiment.

FL training using early-stage layer freezing approaches 100 uses the VGG11 model on CIFAR-10 dataset. VGG11 is a Convolutional Neural Network (CNN) architecture comprising eight convolutional layers and three fully connected layers. CIFAR-10 is one of the most widely used datasets for machine learning research.

FIG. 1a compares the test accuracy of “vanilla” FL 110 to AutoFreeze 120, an aggressive early-stage layer freezing method that freezes layers with the lowest N percentile of change rate of gradients, regardless of whether they have converged or not. A significant accuracy loss of 6.34% 130 is observed due to the premature freezing of layers in the early stages.

In FIG. 1b, FL test accuracy 150 reduces as the number of frozen layers increases using transfer learning based early-stage freezing. An alternate early-stage layer freezing method is based on transfer learning where the layers are frozen before training but are initialized with the corresponding parameters of a pre-trained model, known as pre-training initialization. The rationale is that the initial layers share general function across different datasets. Thus, pre-trained weights from a different dataset can be directly applied to the frozen layers.

FIG. 1b shows the test accuracy obtained when applying transfer training-based layer freezing to FL training for varying number of frozen layers. FIG. 1b shows that the final accuracy reduces as the number of frozen layers increases when using the weights of the pretrained ImageNet model. FIG. 1b shows the accuracy for No Freeze 160, 1 Layer Frozen 162, 2 Layers Frozen 164, 4 Layers Frozen 166, 6 Layers Frozen 168, and 8 Layers Frozen 170. When the number of frozen layers exceeds four layers there is an accuracy loss of at least 3% 180. This observation highlights that a few layers are able to be frozen when applying pre-training layer freezing without incurring a substantial accuracy loss. However, determining the optimal number of layers that can be frozen is a challenge. Moreover, the domain shift between the target dataset and pre-trained dataset can further degrade the final accuracy.

Accuracy-guaranteed layer freezing analyzes the convergence of layers during training to determine whether to freeze them. A common approach to analyze layer convergence is calculating the change of gradients. In response to the change for a layer being small, such as under a pre-defined threshold, then given small updates to the gradients, the layer can be frozen.

To evaluate accuracy-guaranteed layer-freezing, we applied the Automatic Layer Freezing (ALF) method to FL for training the VGG11 model and CIFAR-10 dataset. The gradient of each layer during training is monitored.

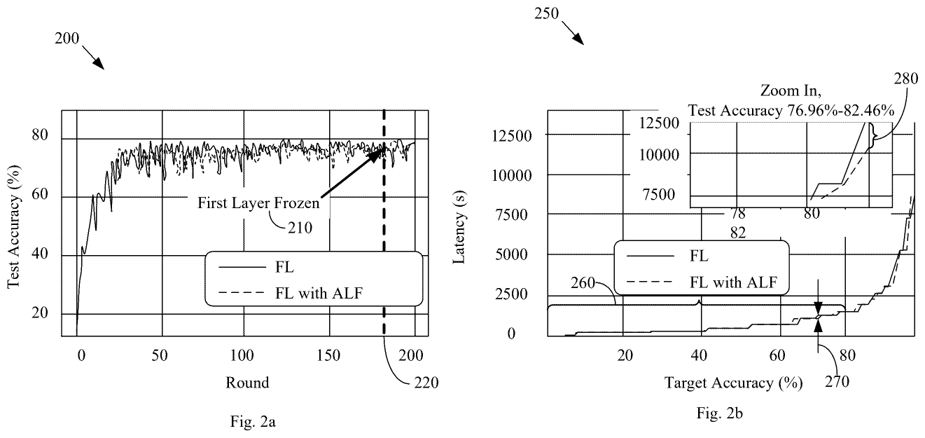

FIG. 2a shows the test accuracy 200 for different rounds in FL training with accuracy-guaranteed layer freezing for VGG11 on CIFAR-10.

In FIG. 2a, FL with ALF 210 (Accuracy-Guaranteed Layer Freezing) achieves the same accuracy as classic FL 220. However, the first layer 210 is frozen at round 181, resulting in minimal speedup. In addition, there are no perceived benefits from accuracy-guaranteed layer freezing in the earlier FL rounds as no layers are noted to be frozen.

FIG. 2b show the latency 250 incurred for a target accuracy in FL training with accuracy-guaranteed layer freezing for VGG11 on CIFAR-10. FIG. 2b details the latency incurred to achieve a target accuracy during training. As presented in FIG. 2b, for a wide-range of target accuracies 260, accuracy-guaranteed layer-freezing does not provide any training acceleration 270 and towards the end of training achieves a marginal speedup 280.

Existing layer freezing approaches are able to either learn quickly or learn effectively, but not both. One observation is that the bottom-up learning dynamic highlights that different layers of a Deep Neural Network (DNN) use different levels of training for converging.

The initial (or bottom) layers of a DNN converge first before the later (or top) layers, referred to as the bottom-up learning dynamic. This enables bottom-up layer freezing during training to reduce computation. To verify the bottom-up dynamic in the FL context, a post-hoc layer-wise convergence analysis using the Singular Vector Canonical Correlation Analysis (SVCCA) technique after training a VGG11 model on the CIFAR-10 dataset is analyzed. The SVCCA score is computed for each layer, which is a normalized score ranging from 0 to 1 that quantifies the correlation between the in-training parameters and the final parameters of a layer. A higher score indicates a higher degree of convergence.

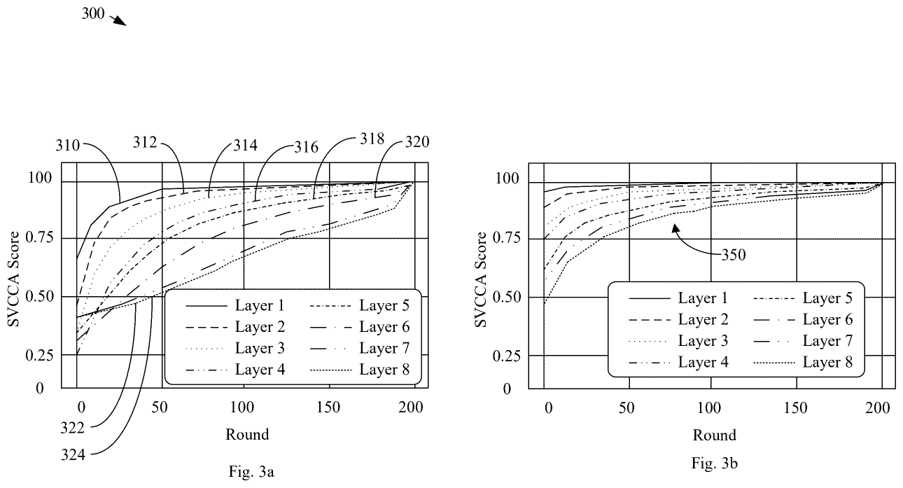

FIGS. 3a-b are plots 300 of the Singular Vector Canonical Correlation Analysis (SVCCA) Score of each VGG11 layer during FL training.

FIG. 3a shows the SVCCA Score vs Round for Layer 1 310, Layer 2 312, Layer 3 314, Layer 4 316, Layer 5 318, Layer 6 320, Layer 7 322 and Layer 8 324 in the context of FL training with random initialization. FIG. 3a shows that the bottom-up dynamic holds in the context of FL training with random initialization. In addition, the use of pre-trained initialization improves the convergence speed, particularly for bottom layers. FIG. 3a highlights the first observation—the bottom layers, e.g., Layer 1 310, rely on fewer updates to reach the final parameters than the top layers, e.g., Layer 8 324.

In FIG. 3b, pre-trained initialization is shown to accelerate convergence 350, especially for the bottom layers.

A second observation is that multiple local learning updates result in overfitted local models. In each FL training round, the global model downloaded from the server is independently trained on each device with local data. A fundamental difference between FL training and traditional Distributed Stochastic Gradient Descent (DSGD) is the number of gradient updates in local learning. DSGD uses one or a small number of local gradient updates on each device followed by global aggregation. This is suitable for distributed learning within a cloud data center. However, in FL, the communication between devices and the server is a bottleneck since the available network bandwidth is relatively limited when compared to a cloud cluster. Therefore, in each local training round, the global model is repeatedly updated on the local dataset with multiple update steps that iterate over the local samples multiple times. However, multiple local updates lead to overfitted models on local datasets. Moreover, in FL, the local dataset is typically non-Independent and Identically Distributed (non-I.I.D.).

Based on the above two observations, there is an opportunity to reduce the computations arising from “oversupplied” training by applying layer freezing for the bottom layers even in the early-stage of FL training. This motivates the design of an ‘aggressive’ but ‘temporary’ layer freezing strategy during initial training layers, either due to their faster convergence or overfitting. Meanwhile, a more “conservative” but ‘permanent’ layer freezing strategy is employed on the server to achieve a higher final accuracy.

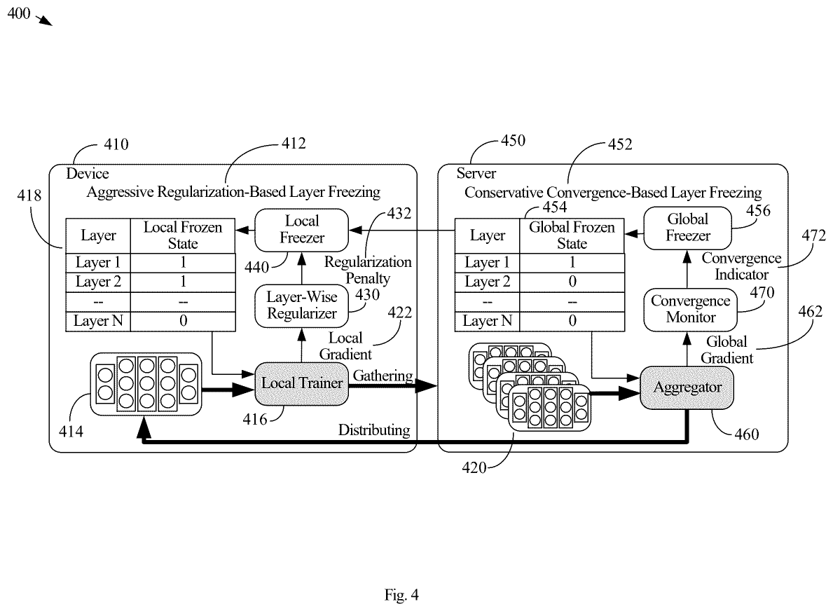

FIG. 4 is a block diagram of a system 400 that provides an efficient layer freezing framework for FL according to at least one embodiment.

In FIG. 4, device-side layer freezing 410 and server-side layer freezing 450 are decoupled to accelerate early-stage device training and achieve a high global model accuracy. This separation between the device-side layer freezing 410 and server-side layer freezing 450 allows different freezing strategies to be used on the device and server, thereby accelerating local training and achieving a highly accurate global model for FL. The device-side layer freezing 410 is based on local Aggressive Regularization-Based Layer Freezing 412, and server-side layer freezing 450 is based on a global Conservative Convergence-Based Layer Freezing 452.

On the device-side 410, Global Gradients of a Global Model 414 are received from the server-side 450 for each round of local training. The Global Gradients of a Global Model 414 received from the server includes an aggregation of Global Gradients of a Global Model 414 generated by the plurality of devices. On a device, for each round of local training, after receiving The Global Gradients of a Global Model 414 from the server 450, Local Trainer 416 iteratively updates the Local State List 418 of the Local Model for several epochs (an epoch is the complete training over the data points). The Local Trainer of the devices then provides the Updated Local Models 420 to the server-side 450. Local Trainer generates Local Training Gradients 422 based on the updated Global Model 414 and the Local State List 418. Local Trainer 416 provides the Local Training Gradients 422 to a Layer-Wise Regularizer 430.

On the device-side 410, Aggressive Regularization-Based Layer Freezing 412 is applied to identify local layers to freeze in a local model to accelerate local learning, even for the initial FL rounds. A two-step process is developed for generating a Local State List of the layers of the Local Model 418 that are frozen, which is referred to as the Local State List. The Local State List 418 is used during training. Local Layer-Wise Regularizer 430 receives the Local Training Gradients 422 from the Local Trainer 416 for generating a Layer-Wise Regularization Penalty Scheme 432. Local Layer-Wise Regularizer 430 analyzes the Local Training Gradients 422 to generate the Layer-Wise Regularization Penalty Scheme 432.

A Local Freezer 440 combines the Local Regularization Penalty Scheme 432 with the Global State List 454 of the Global Model produced on the server-side 450 by Global Freezer 456 to identify local layers to freeze in a local model. The list of frozen layers received from the Global Freezer 456 is referred to as the Global State List 454. The state of the layers from the Local State List 418 is used by the Local Trainer 416 to freeze the layers in the next training iteration. Local Freezer 440 applies a local freezing matrix as a mask to filter layer parameters.

On the server-side 450, after receiving the Local Model Updates 420 from the devices, a Global Aggregator 460 aggregates local gradients using aggregation algorithms, such as FedAvg, to produce Global Gradients 462. Conservative Convergence-Based Layer Freezing 452 is used on the server-side 450 to maintain the final accuracy.

A Convergence Monitor 470 receives the Global Gradients 462 from Global Aggregator 460. The Convergence Monitor 470 analyzes the convergence behavior of the global model and sends a corresponding Convergence Metric 472 (i.e., the convergence metrics of each layer) to the Global Freezer. The Convergence Metric 472 is also referred to the Convergence Indictor for layers of the Global Model 454. The Global Freezer 456 produces the Global State List 454 that is used by the Global Aggregator 460 to freeze the layers of the global model. The Global State List 454 is also sent to the local devices to be used by the Local Freezer 440. Thus, distinct freezing strategies are used on the devices 410 and the server 450, which enables simultaneously acceleration of local training as well as a higher global accuracy.

A Parallel Device/Server Freeze Framework according to at least one embodiment implements an algorithm to repetitively performs two stages of round training, i.e., parallel local learning and synchronized global aggregation, until the optimal model θ* is obtained. An embodiment of an algorithm is shown below:

```
  1 Input: Initial global weight θ⁰ and data [symbol]    := { [symbol] ₖ}ₖ₌₁^{K}
  2 Output: θ*
  3 θ^{r} ← θ⁰, [symbol] ^{r} ← 1^{|θ|}
  4-23 Perform parallel local learning
  4 For each round r ϵ [symbol]  do
  5 For each device k ϵ K in parallel do
  6 θₖ^{t} ← θ^{r}, [symbol] ^{r};
  7 For each local iteration t ϵ T do
  8 if t ≤ ∈ · T, then
  9 /*Apply global freezing matrix*/
10 θₖ^{t+1} = θₖ^{t} − γ( [symbol] ^{r} ⊙∇ [symbol]  ₖ(θₖ^{t}));
11 End
12 Else
13 /*Monitor local gradient*/
14 ∇ [symbol]  ₖ(θₖ^{ϵ·T}) = θₖ^{ϵ·T} − θ^{r};
15 /*Generate local freezing matrix*/
16 [symbol]  ₖ^{r} ← ∇ [symbol]  ₖ(θₖ^{ϵ·T});
17 [symbol]  ₖ^{r} ← [symbol] ₖ^{r} ∪ [symbol] ^{r};
18 /*Apply local freezing matrix*/
19 θₖ^{t+1} = θₖ^{t} − γ( [symbol] ₖ^{r} ⊙∇ [symbol]  ₖ(θₖ^{t}));
20 End
21 End
22 ∇ [symbol]  ₖ(θₖ^{t}) = θₖ^{T} − θ^{r};
23 End
24-30 Perform synchronized global aggregation until optimum model is obtained
24 /*Monitor global gradient*/
25 Collect gradients ∇ [symbol] ₖ(θₖ^{r}) from each device k;
```

| | |
|---|---|
| 26 | $∇ ℱ ( {θ}^{r} ) = {\sum }_{k = 1}^{K} \frac{\vert {𝒟}_{k} \vert}{\vert 𝒟 \vert} ∇ {ℱ}_{k} ( {θ}_{k}^{r} ) ;$ |

27 /*Apply global freezing matrix*/
28 θ^{r+1} = θ^{r} − γ( [symbol] ^{r} ⊙∇ [symbol] (θ^{r}));
29 /*Generate global freezing matrix*/
30 [symbol] ^{r+1} + ∇ [symbol] (θ^{r})
31 end
32-33 produce optimal model
32 θ* ← θ^{R};
33 return θ*

### Parallel Local Learning

When each device k receives the global weights θr from the server in round r (line 6), local updates are independently performed by each device on θₖ^{t} for T iterations (Line 7-Line 23). For the first ϵ·T iterations, the Parallel Device/Server Freeze Framework according to at least one embodiment applies the global freezing matrix [symbol] for updating the model (Line 10). This set of iterations is also utilized for collecting layer-wise gradients to generate the local freezing matrix [symbol] . After ϵ·T iterations, a local freezing matrix [symbol] is calculated based on the accumulated gradient ∇ [symbol] (θₖ^{ϵ·T}) (Line 16). The local freezing matrix is then merged with the global freezing matrix [symbol] (Line 17). The local freezing matrix [symbol] is used to mask the model update (Line 19). At the end of local training, the accumulated gradient is sent to the server (Line 22).

### Synchronized Global Aggregation

After the server receives the updated gradients from the devices for a round r (Line 25), the server performs a gradient update on the global model. Initially, the server aggregates the gradients from devices to generate an updated gradient ∇ [symbol] (θ^{r}) (Line 26). Subsequently, the aggregated gradient ∇ [symbol] (θ^{r}) is used to update the global model with the global freezing matrix [symbol] (Line 28). Moreover, the server analyzes convergence on the global gradient ∇ [symbol] (θ^{r}) and updates the global freezing matrix (Line 30).

A Parallel Device/Server Freeze Framework according to at least one embodiment implements aggressive regularization-based layer freezing on the device-side and conservative convergence-based layer freezing on the server-side. Formulation of regularization loss according to at least one embodiment facilitates regularization-based layer freezing. The conservative convergence-based layer freezing on the server-side obtains high accuracy.

### Aggressive Regularization-Based Layer Freezing

Aggressive regularization-based layer freezing according to at least one embodiment is based on local training with layer regularization: As described above, individual DNN layers converge in a bottom-up manner during FL training, and multiple local learning updates on the local dataset results in over-fitting. Over-fitting is addressed by adding an extra regularization term on the traditional loss (e.g., cross entropy loss). A Parallel Device/Server Freeze Framework according to at least one embodiment adds an additional regularization term on the local training to reduce the gap between the initial weights er of round r and its local updates as shown below:

$${min}_{θ} {F}_{k} ( θ ; {θ}^{r} )$$

$$s . t . {F}_{k} ( θ ) = {\underbrace{\frac{1}{\vert {𝒟}_{k} \vert} {\sum }_{{ς}^{t} \sim {𝒟}_{k}} {ℱ}_{k} ( θ ; {ς}^{t} )}}_{Normal Loss} + + {\underbrace{μ ‖ θ - {θ}^{r} ‖}}_{Regularization Loss} \qquad ( 7 )$$

where θ^{r} is the initial weights and μ is a penalty coefficient for the change of the model parameters, ∥θ−θ^{r}∥. For larger values of μ, a larger penalty is added to the loss. This regularization term guides the optimization of weights θ to mitigate the effect of statistical heterogeneity of local Non-I.I.D. data. The additional regularization term ∥θ−θ^{r}∥ is equal to the norm of the gradient. Therefore, it facilitates faster convergence of parameters by encouraging small parameter updates. Although adding the layer regularization loss is able to result in faster convergence, the addition of layer regularization loss does not provide any early-stage acceleration in FL because, at the start of training, the normal loss dominates the gradient updates, while regulation loss has a minor impact. Thus, a reformulation of loss regularization is used for layer freezing on the device side.

In each local training round r, loss regularization represented as μ∥θ−θ^{r}∥ accelerates convergence by adding the regularization term to the local loss function [symbol] (θ). However, the penalty during training is not able to be controlled as the penalty is jointly optimized with the normal learning loss. Furthermore, the regularization loss does not directly result in computational savings during the early stages. To address this issue, loss regularization is reformulated and an algorithm is used to enable early-stage layer freezing that has same effect as traditional loss regularization.

In the local learning of global round r of FL, device k updates the model from the initialized θ^{r} for T iterations over the dataset [symbol] ₖ. For each iteration T, the model is updated as follows:

$${θ}^{t} = {θ}^{t - 1} + {△θ}^{t} where {△θ}^{t} = γ ∇ {ℱ}_{k} ( {θ}^{t} ) , \qquad ( 8 )$$

wherein Δ θ^{t} represents the parameter changes, which are equal to the product of the γ (learning rate) and ∇ [symbol] (θ^{t}) (the gradient). Therefore, the loss regularization term after T iterations μ∥θ^{T}−θ^{r}∥ is reformulated as:

$${μ {‖ {θ}^{T} - {θ}^{r} ‖}^{2} = μ {‖ {θ}^{T} - {θ}^{0} ‖}^{2} = μ {‖ ( {θ}^{T - 1} + {△θ}^{T} ) - {θ}^{0} ‖}^{2} = μ {‖ ( {θ}^{T - 2} + {△θ}^{T - 1} ) - {△θ}^{T} ‖}^{2} = μ ‖ ( ( {θ}^{0} + {△θ}^{1} ) - {△θ}^{2} ) + ⋯ + {△θ}^{T} ) - {θ}^{0} ‖}^{2} = μ {‖ {θ}^{1} + {θ}^{2} + ⋯ + {△θ}^{T} ‖}^{2} = μ {‖ {\sum }_{t = 0}^{T} {△θ}^{t} ‖}^{2} \qquad ( 9 )$$

An assumption is made that the squared norm of the stochastic gradient has an upper bound on the local objective function, i.e., ∥∇ [symbol] (σ^{t})∥²≤G∀k, ∀t. In addition, for each layer i(θᵢ^{t}), there is a corresponding upper bound, i.e., ∥∇ [symbol] (θᵢ^{t})∥≤Gᵢ, ∀k, ∀t. Based on this assumption, the upper bound of loss regularization for T iterations is as follows:

$$μ {‖ {\sum }_{t = 0}^{T} {△θ}^{t} ‖}^{2} \leq μ {\sum }_{t = 0}^{T} {‖ ( {θ}^{t} ) ‖}^{2} \leq μγ TG , \qquad ( 10 )$$

where μ is the penalty coefficient that controls the degree of penalty. For local training of T iterations, the loss regularization μ∥θ^{t}−θ^{r}∥² has a upper bound of penalty μγTG on overall updates. In terms of layer i, the regularization upper bound is μγTG.

Given the upper bound of the regularization term (μγTGᵢ), regularization is incorporated into local training of different layers by using layer freezing. For traditional loss regularization, T is a fixed constant for the layers, and the layer-wise regularization effect is achieved by reducing the norm of gradient Gᵢ through the loss optimization. An alternative approach to applying the same regularization penalty is to limit the parameter Tᵢ for different layers instead of reducing Gᵢ. In other words, different lengths of iterations (Tᵢ) are able to be allocated for each layer i to be trained to achieve the same regularization target (Equation 9) as traditional loss regularization.

### Determining Tᵢ for Each Layer

In the traditional loss regularization term μγTGᵢ, in response to a layer having a large Gᵢ (the upper bound of the gradient of layer i), the regularization loss applies a larger penalty on this layer. Based on this, An automatically determination of Tᵢ based on the Gᵢ of the layer is made. Therefore, for local training of T iterations, Tᵢ of layer i is calculated using:

$${T}_{i} = μ Tx \frac{{G}_{min}}{{G}_{i}} , \qquad ( 11 )$$

where Gᵢ is the gradient upper bound of layer i and Gₘᵢₙ is the minimum Gᵢ of the layers. Equation 11 ensures that the layer with a higher Gᵢ will be penalized more by being allocated with a smaller Tᵢ for training. In practice, the exact value of Gᵢ is not known as it is the theoretical upper bound of the gradient. Therefore, the average value of the gradient for layer i is used as an estimate of Gᵢ.

### Adaptive Changes Of Tᵢ

Traditional loss regularization dynamically adjusts the penalty as training progresses—as Gᵢ becomes smaller, the regularization penalty automatically diminishes. In line with this, Tᵢ is adaptively adjusted. The values of Gᵢ across layers in the first round are recorded and the average, denoted as G̅⁰, is calculated. For the subsequent rounds, the penalty u is adjusted by considering the change of G̅^{r}, with μ=μ×G̅⁰/G̅^{r}. Therefore, as Gᵢ decreases during training, μ becomes larger, resulting in less regularization penalty on each layer.

### Overall Pipeline

At the start of local training of T iteration, the layers are trained for ϵ·T iterations to estimate Gᵢ of layer i. For the remaining iterations (1−ϵ)·T, layer i will be trained for only Tᵢ iterations calculated using Equation 11. Since ϵ·T iterations are used for estimating Gᵢ, the remaining iterations (1−ξ)·T are used to calculate Tᵢ instead of T.

In addition, μ is dynamically optimized based on the changes in the average gradients of layers G̅^{r}.

### Conservative Convergence-Based Layer Freezing

On the server-side, a conservative convergence-based strategy is adopted to apply layer freezing so as to guarantee the final accuracy. The parameters of the layer are monitored to determine whether a layer has converged.

### Metrics for Measuring Layer Convergence

There are two metrics for measuring layer convergence. First, gradient-based metric determines the stability of the layers by checking whether there is a change of gradient for a layer. Secondly, activation-based metric determines the stability by assessing the activation generated by a layer.

In a Parallel Device/Server Freeze Framework according to at least one embodiment, the gradient-based metric is adopted because the activation-based metric often uses a reference model for comparison, which is impractical in FL. The use of an in-training model instead of a fully-trained model as a reference model is unrealistic in a real-world FL setting because parallel training of a reference model on devices is to be used. The Convergence Monitor records the average norm of the server-side gradients for each layer. In addition, the Exponential Moving Average (EMA) method, for example, is able to be used to calculate the EMA of the average norm of server gradients to minimize the impact of gradient variation. Saving the latest gradient in the memory is more computationally efficient.

### Determining if a Layer has Converged

On the server-side, in response to a layer in the global model being frozen, the parameters of the layers are not updated during both global aggregation and local learning for the remaining rounds. Therefore, a conservative criteria is adopted to ensure that the final accuracy of the global model is not reduced. Two stringent conditions are set by the Global Freezer to determine whether the layer has converged and avoid premature layer freezing.

Condition 1 is that the EMA of the average norm of server-side gradients for a layer is below a pre-defined threshold compared to the initial gradients;

Condition 2 is that the change of the EMA gradient is considered to be negligible in response to being less than a predefined threshold.

The rationale behind these two conditions is to ensure that the gradient of the layer is smaller than the initial gradient (Condition 1), and there will be no significant future change to the gradient (Condition 2). When both these conditions are satisfied, the Global Freezer considers the layer to have converged and will freeze it. The choice of the two pre-defined thresholds is discussed in more detail below.

### Bottom-Up Layer Freezing

The order in which the layers are frozen determines whether computational benefits to training exist. Freezing a layer accelerates training in response to the preceding layers of a given layer being frozen. This is also referred to as gradient locking introduced by back propagation. Layers of the model converge in a bottom-up manner during the training. Bottom-up learning is empirically verified to hold in FL (Observation 2 in Section 3.1). Therefore, a Parallel Device/Server Freeze Framework according to at least one embodiment adopts bottom-up layer freezing and freezes a layer if the preceding layers are already frozen.

### Evaluation

The results obtained from evaluating the Parallel Device/Server Freeze Framework according to at least one embodiment are presented herein. Specifically, the end-to-end performance and the performance breakdown by comparing Parallel Device/Server Freeze Framework according to at least one embodiment to other state-of-the-art baselines. In addition, the impact of hyper-parameters and system overhead are discussed. The experimental setup for this evaluation, including the selected baselines, datasets, experimental testbed and DNN models is now described.

The setup, namely the datasets and models, training hyperparameters, experimental testbed, baselines and the metrics, used to evaluate the Parallel Device/Server Freeze Framework is considered here.

### Datasets and Models

Parallel Device/Server Freeze Framework according to at least one embodiment is evaluated on three datasets with distinct levels of difficulty, namely FMINST, CIFAR-10, and CIFAR-100. For data partitioning on devices, a non-independent and identically distributed (non-I.I.D.) setting of FL is simulated. The dataset is sorted based on labels to create 500 shards. Each device is randomly assigned 5 shards, such that each device has training samples from up to half of the available classes. The test dataset is on the server for evaluating model performance after each training round.

Three popular convolutional neural networks (CNNs) are trained: LeNet (lightweight CNN), VGG11 (plain CNN), and ResNet12 (residual CNN) are trained using the FMNIST, CIFAR-10, and CIFAR-100 datasets, respectively. LeNet (lightweight CNN) is a simple convolutional neural network structure. VGG11 is a Convolutional Neural Network (CNN) architecture comprising eight convolutional layers and three fully connected layers. Residual Neural Network-12 (ResNet12) is a 12-layer residual network. FMNIST (Fashion-Modified National Institute of Standards and Technology) is an image dataset. CIFAR-10 (Canadian Institute for Advanced Research, 10 classes) is a dataset of images with 10 classes. CIFAR-100 dataset is a dataset of images with 100 classes.

The architectures of the CNNs are shown in Table 1.

TABLE 1

| Dataset | Model | Architecture |
|---|---|---|
| FMNIST | LeNet | C6-MP-C16-MP-FC120-FC84-FC10 |
| CIFAR-10 | VGG11 | C64-MP-C128-MP-C256-C256-MP-C512- |
| | | C512-MPC512-C512-FC512-FC512-FC10 |
| CIFAR-100 | ResNet12 | C64-MP-C64-MP-RB64-RB128-RB256- |
| | | FC100 |

In Table 1, in the evaluated models, convolution layers are denoted as C followed by the number of filters. Filter size of a convolution layer is 5×5 for LeNet and 3×3 for VGG11 and ResNet12, except for down-sampling convolution which is 1×1. Max Pooling layer is MP, Fully Connected layer is FC; and Residual Block (RB) includes two convolution layers and a down-sampling convolution layer. The number following the designations is the number of output channels. The batch normalization layer is applied after every convolutional layer in VGG11 and ResNet12.

### FL Training Hyper-Parameters

For each FL round, 10 devices are uniformly sampled from a pool of 100 devices participating in a round of training. The most popular aggregation algorithm is adopted, i.e., standard FedAvg for the Global Aggregator on the server-side. The same data augmentation of horizon flip and random crop is used for experiments. The stochastic Gradient Descent (SGD) optimizer with a constant learning rate of 0.01 is employed. A total of 200 rounds is set for training on the datasets. For local training, the local epoch is set to 10 for the datasets. The pretrained weights of VGG11 are obtained from the PyTorch Model Zoo that was trained on the ImageNet dataset, while the pre-trained weights of LeNet and ResNet12 are trained on the Tiny-ImageNet dataset.

### Testbed

To evaluate the system performance (i.e., training latency), two prototypes are used. The first is a Raspberry Pi (low-end IoT device) cluster and the second is a Jetson Nano (high-end IoT device) cluster. The Raspberry Pi cluster consists of 10 Raspberry Pi 4 Model B single-board computers, each with a 1.5 GHz quad-core ARM Cortex-A53 CPU. A laptop serves as the edge server that has a 2.5 GHZ Intel i7 8-core CPU and 16 GB RAM. In the Jetson Nano cluster, 10 Jetson Nano development boards are used, each with a 1.43 GHz quad-core ARM Cortex-A57 CPU and a 128-core Maxwell GPU. The devices are connected to a cloud server with 2 GHz AMD EPYC 7713P 64-Core CPU, 252 GB RAM, and an Nvidia A6000 GPU. Communication between devices and the server is using socket TCP with a bandwidth of 100 Mbps. The devices and the server use PyTorch as the training framework.

### Choice Of Baselines

Vanilla FL is considered first, which refers to the training of classic FL without using layer freezing. State-of-the-art layer freezing methods are considered in both centralized and FL training contexts. In the context of FL, Automatic Layer Freezing (ALF) is selected, which is a convergence-based layer freezing approach for the server-side. Automatic Layer Freezing (ALF) calculates a metric referred to as “perturbation effectiveness” to analyze the convergence of layers. The same metric is reported in Adaptive Parameter Freezing (APF). However, APF conducts fine-grained parameter freezing thereby making it impractical for accelerating training and is not considered to evaluate Parallel Device/Server Freeze Framework according to at least one embodiment.

In the context of centralized training, AutoFreeze is extensively utilized for layer freezing in traditional centralized training, and AutoFreeze is adapted for FL by applying it on the server side. Egeria has demonstrated superior performance compared to AutoFreeze. However, Egeria relies on a “reference model” to guide the analysis of layer convergence, which involves parallel-training of a reference model on the server. Thus, the Egeria approach is impractical for FL because training data is distributed across devices making the simultaneous training of the reference model not possible. In summary, Parallel Device/Server Freeze Framework according to at least one embodiment is compared with three baselines, namely Vanilla FL, ALF and AutoFreeze.

### End-to-End Performance

Table 2 summarizes the evaluation by presenting the highest test accuracy achieved and total training latency along with speedups compared to vanilla FL.

TABLE 2

| | | | | Methods | | | |
|---|---|---|---|---|---|---|---|
| | | | | | | | Freezing |
| Dataset | Testbed | Model | Initialization | Vanilla FL | ALF | AutoFreeze | Framework |
| FMNIST | Raspberry Pi | LeNet | Random | 89.57% | 89.78% | 88.75% | 89.16% |
| | | | | 19480 s (1x) | 17426 s (1.12x) | 13821 s (1.41x) | 15031 s (1.3x) |
| | | | Pre-trained | 89.67% | 89.61% | 87.91% | 89.21% |
| | | | | 18882 s (1x) | 18668 s (1.01x) | 12907 s (1.46x) | 15402 s (1.23x) |
| CIFAR-10 | Jetson Nano | VGG11 | Random | 82.60% | 81.96% | 76.26% | 80.93% |
| | | | | 13365 s (1x) | 12972 s (1.03x) | 8795 s (1.52x) | 12517 s (1.07x) |
| | | | Pre-trained | 88.52% | 87.92% | 87.03% | 87.96% |
| | | | | 13259 s (1x) | 13259 s (1x) | 9839 s (1.35x) | 11579 s (1.15x) |
| CIFAR-100 | Jetson Nano | ResNet12 | Random | 28.54% | 29.28% | 28.60% | 28.96% |
| | | | | 4181 s (1x) | 4187 s (1x) | 3469 s (1.21x) | 3839 s (1.09x) |
| | | | Pre-trained | 36.19% | 36.81% | 35.30% | 35.62% |
| | | | | 4159 s (1x) | 4083 s (1.02x) | 3577 s (1.16x) | 3633 s (1.14x) |

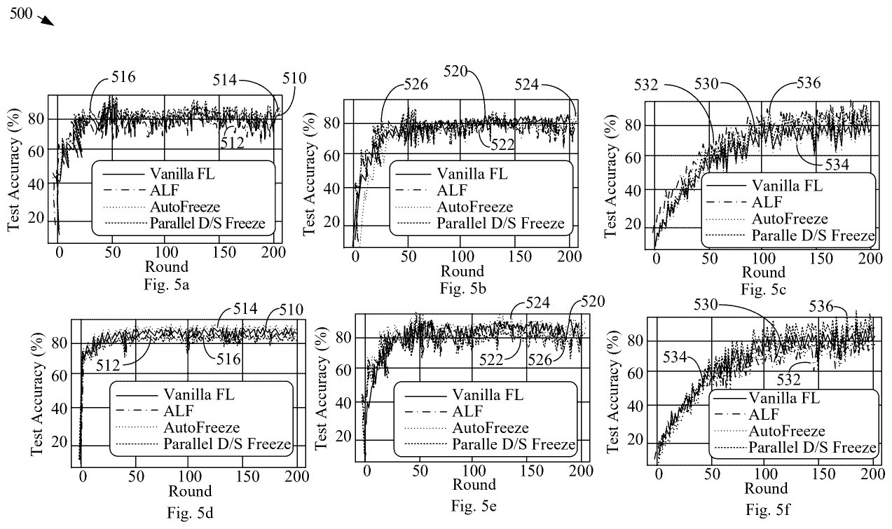

FIGS. 5a-f show the test accuracy curves for 3 network structures, LeNet (lightweight CNN), VGG11 (plain CNN), and ResNet12 (residual CNN), that are trained using the three different datasets, FMNIST, CIFAR-10, and CIFAR-100 datasets, respectively. FIG. 5a shows Random LeNet on FMNIST. FIG. 5b shows Random VGG11 on CIFAR-10. FIG. 5c shows Random ResNet12 on CIFAR-100. FIG. 5d shows Pre-Trained LeNet on FMNIST. FIG. 5e shows Pre-Trained VGG11 on CIFAR-10. FIG. 5f shows Pre-Trained ResNet12 on CIFAR-100.

### Training LeNet on FMNIST

A LeNet model is trained using the FMNIST dataset on the Raspberry Pi testbed. The LeNet model contains two convolutional layers and three fully-connected layers, making it computationally lightweight. However, LeNet still uses up to 19480s (5.4 hours) for training vanilla FL.

FIG. 5a and FIG. 5d show the test accuracy curves of Vanilla FL 510, ALF 512, AutoFreeze 514, and the Parallel Device/Server Freeze Framework according to at least one embodiment 516 on FMNIST for LeNet. Baselines, including Parallel Device/Server Freeze Framework according to at least one embodiment 516, converge rapidly, reaching a relatively high accuracy after around 50 rounds. Specifically, for random initialization, 87.39%, 88.19%, 88.02%, and 87.7% accuracy, and for pretrained initialization, 88.35%, 87.37%, 87.45%, and 87.87% accuracy is achieved for Vanilla FL 510, ALF 512, AutoFreeze 514, and the Parallel Device/Server Freeze Framework according to at least one embodiment 516, respectively, at round 50. The rapid improvement in the test accuracy of the model provides the opportunity for layers to be frozen, especially in response to approaching the final accuracy by the 50th round. However, ALF 512 has minimal acceleration (1.12× and 1.01× on random and pretrained initialization, respectively) by adopting layer freezing in late stages. AutoFreeze 514 achieves a higher acceleration (1.41× and 1.46× on random and pre-trained initialization, respectively) but has a relatively high accuracy loss of 0.82% and 1.76% compared to Vanilla FL 510.

Parallel Device/Server Freeze Framework according to at least one embodiment 516 balances between accuracy and speedup, with speedups of 1.3× and 1.23× while experiencing less than a 0.5% loss (0.41% and 0.46%) compared to Vanilla FL 510.

### Training VGG11 On CIFAR-10

A larger model is trained, namely the VGG11 model, that has a higher computational overhead than LeNet using the CIFAR-10 dataset on a testbed with GPU enabled devices, namely Jetson Nanos. The VGG11 model has more layers (e.g., eight convolutional layers and three fully-connected layers), which makes layer freezing more complex.

FIG. 5b and FIG. 5e show the test accuracy curves of Vanilla FL 520, ALF 522, AutoFreeze 524, and the Parallel Device/Server Freeze Framework according to at least one embodiment 526 on CIFAR-10 for VGG11 with random and pretrained initialization. There is more variability in training due to the increased complexity of the model and dataset and more training rounds are used to achieve the highest accuracy. A marginal training time improvement is noted for ALF 522 (e.g., 1.03× speedup on random initialization and no speedup on pre-trained initialization). Moreover, ALF 522 has an accuracy loss of around 0.6% for both random and pre-trained initialization even when applying layer freezing in later training rounds. AutoFreeze 524 suffers a large loss when aggressively applying layer freezing in the early stages, with losses of 6.34% and 1.49% on random and pre-trained initialization, respectively, despite achieving speedups of 1.52× and 1.35×.

In contrast, the Parallel Device/Server Freeze Framework according to at least one embodiment 526 still achieves a 1.07× speedup with a 1.67% accuracy loss when trained using random initialization, while with pre-trained initialization, the Parallel Device/Server Freeze Framework according to at least one embodiment 526 has a 1.23× speedup and a relatively small 0.56% accuracy loss compared to Vanilla FL 520.

### Training ResNet12 on CIFAR-100

A ResNet12 model is evaluated on the CIFAR-100 dataset using the Jetson Nano testbed. The residual architecture in the ResNet12 model makes the application of layer freezing more complex compared to a plain convolutional network (e.g., VGG11).

FIG. 5c and FIG. 5f show the test accuracy curves of Vanilla FL 530, ALF 532, AutoFreeze 534, and the Parallel Device/Server Freeze Framework according to at least one embodiment 536 on CIFAR-100 for ResNet12. The training uses more rounds to converge for both random and pre-trained initialization similar to VGG11 on CIFAR-10. For ALF 532, a final accuracy of 29.28% and 36.81% is achieved using random and pretrained initialization, respectively, but does not achieve any notable training acceleration (e.g., 1× and 1.02× on random and pre-trained initialization, respectively). Surprisingly, a better final accuracy is achieved compared to Vanilla FL 530 in the pre-trained setting. Layer freezing in the late stages is believed to stabilize aggregation in FL. AutoFreeze 534 has an acceleration of 1.21× on random initialization with an accuracy of 28.6% and 1.16× speedup with a 0.89% accuracy loss compared to Vanilla FL 530. However, Parallel Device/Server Freeze Framework according to at least one embodiment 516 has superior performance achieving a comparable speedup of 1.09× and 1.14× with a higher final accuracy of 28.96% and 35.62%.

### Summary

As shown in Table 2, Parallel Device/Server Freeze Framework according to at least one embodiment demonstrates competitive highest accuracy compared to Vanilla FL while accelerating training up to 1.3x. Compared to other state-of-the-art baselines, Parallel Device/Server Freeze Framework according to at least one embodiment exhibits better robustness in response to being trained with both random and pre-trained initialization methods, and achieves a better trade-off between accuracy and speedup. In comparison, ALF offers marginal training speedup and AutoFreeze results in significant accuracy loss.

### Performance Breakdown

Taking a closer look at training provides an understanding to the decisions made by Parallel Device/Server Freeze Framework according to at least one embodiment and other baselines. The layer freezing choices made provide valuable insights into accuracy and speedup performance achieved by each method.

### Global Freezing Decisions

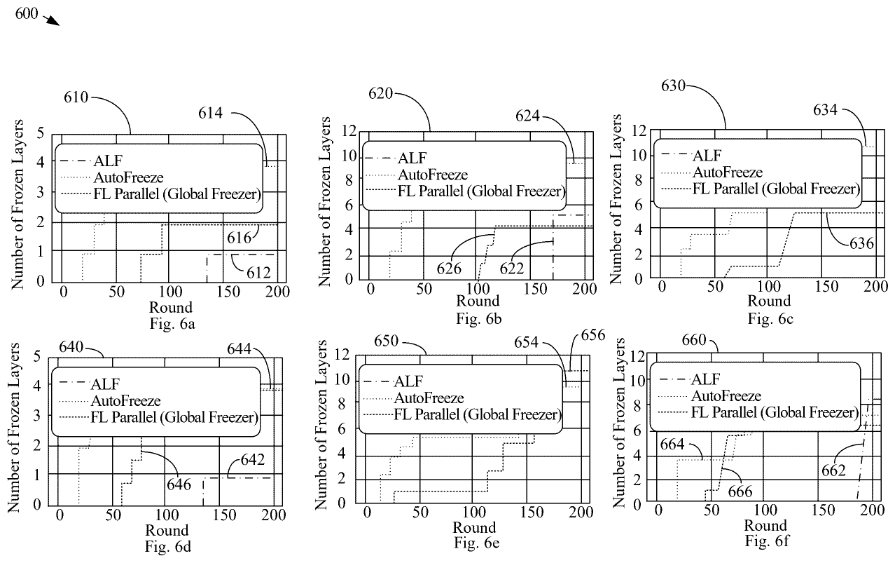

FIGS. 6a-f show the global freezing decisions 600 during the training of the three datasets and the three models with random and pre-trained initialization.

In FIGS. 6a-f, the y-axis represents the number of frozen layers determined by the global freezer. For the LeNet 610, 640, VGG11 620, 650, and ResNet12 630, 660 models, there are a total of 5, 11, and 12 layers, respectively. The freezing of the last layer in each model is excluded. If the last layer is frozen, then the last layer indicates that one or more layers are frozen, and training is stopped. Therefore, the maximum number of frozen layers is 4, 10, and 11 for the models.

ALF 612, 622, 642, 662 only makes freezing decisions in the later training stages and at times does not freeze any layers, leading to a high final accuracy but inefficient training latency. ALF calculates the “perturbation effectiveness” to analyze the convergence of a layer. “Perturbation effectiveness” is a value between 0 and 1 that is uniform across layers. “Perturbation effectiveness” starts at 1 and gradually decreases during training. ALF 612, 622, 642, 662 sets a pre-defined threshold to determine when a layer is frozen. However, this results in layer freezing in the later stages of training, limiting any training acceleration in the early stages. In some cases, as illustrated in FIG. 6c and FIG. 6e, ALF is not shown because ALF does not freeze any layers because the predefined threshold is high. This threshold is unknown prior to training and varies across different datasets, models, and initialization types, thereby posing a challenge to generalization across various settings. Overall, ALF 612, 622, 642, 662 maintains the final accuracy but achieve marginal speedup for the training.

AutoFreeze 614, 624, 634, 644, 654, 664 aggressively freezes bottom layers in the early stages, resulting in training speedups, but the premature freezing of layers leads to a significant accuracy loss. AutoFreeze 614, 624, 634, 644, 654, 664 adopts a more aggressive approach to layer freezing by not requiring a layer to be converged. Specifically, AutoFreeze 614, 624, 634, 644, 654, 664 calculates the rate of change in gradient norm at fixed intervals and sorts layers based on the rate. As training progresses, the rate of change in the gradient norm decreases, allowing layers to be frozen accordingly. However, instead of enforcing a target rate threshold for each layer, which is unknown before training and results in later stage freezing like ALF, AutoFreeze 614, 624, 634, 644, 654, 664 adopts a more aggressive strategy. AutoFreeze 614, 624, 634, 644, 654, 664 freezes a layer in response to its rate of change in gradient norm falling within the N-percentile of the layers. This relaxation enables AutoFreeze 614, 624, 634, 644, 654, 664 to freeze layers early, resulting in speedups. However, freezing immature layers leads to a significant accuracy loss. For instance, in response to training VGG11 using random initialization, which uses more training for each layer, AutoFreeze 624, 654 freezes the bottom layers (layers 1 to 5) before 50 rounds, resulting in a substantial accuracy loss (6.34%).

Parallel Device/Server Freeze Framework according to at least one embodiment 616, 626, 636, 646, 656, 666 balances better between accuracy and speedup with moderate global freezing decisions in both random and pre-trained initialization contexts. The freezing decisions made by Parallel Device/Server Freeze Framework according to at least one embodiment 616, 626, 636, 646, 656, 666 is made at the Global Freezer module. Parallel Device/Server Freeze Framework according to at least one embodiment 616, 626, 636, 646, 656, 666 makes global freezing decisions based on two conditions discussed above. Compared to ALF, Parallel Device/Server Freeze Framework according to at least one embodiment 616, 626, 636, 646, 656, 666 makes more aggressive freezing decisions by evaluating gradient changes. Therefore, Parallel Device/Server Freeze Framework according to at least one embodiment 616, 626, 636, 646, 656, 666 relies on less prior knowledge compared to ALF, as finding a uniform freezing criteria for layers is challenging, rendering it impractical. In comparison to AutoFreeze, Parallel Device/Server Freeze Framework according to at least one embodiment 616, 626, 636, 646, 656, 666 decides on permanent freezing of a layer in Global Freezer, thereby minimizing the impact on final accuracy, while leaving early-stage freezing to the regularization based Local Freezer. Parallel Device/Server Freeze Framework according to at least one embodiment 616, 626, 636, 646, 656, 666 achieves early freezing of the bottom layers while avoiding premature freezing of layers on the server. In addition, FIGS. 6a-f also demonstrate the ability of Parallel Device/Server Freeze Framework according to at least one embodiment 646, 656, 666 to adapt to pre-trained initialization, thereby allowing for more extensive layer freezing compared to random initialization. This is evident by the aggressive freezing in the pre-trained setting of Parallel Device/Server Freeze Framework according to at least one embodiment 646, 656, 666, which is not the case in ALF and AutoFreeze as shown in FIGS. 6a-f.

Unlike ALF and AutoFreeze, Parallel Device/Server Freeze Framework according to at least one embodiment 616, 626, 636, 646, 656, 666 also employs local freezing decision made by the Local Freezer. The Local Freezer adopts regularization-based layer freezing-layers are temporarily frozen for several iterations instead of freezing them.

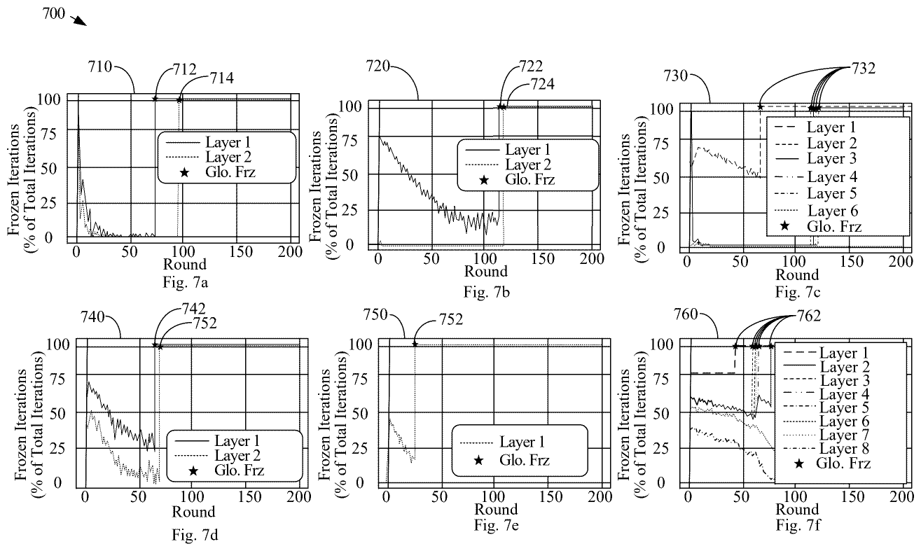

FIGS. 7a-f shows the local freezing decisions 700 made by Parallel Device/Server Freeze Framework according to at least one embodiment during the training. The absolute value of iterations is normalized into percentages of the total iterations for each round. The results highlight the ability of Parallel Device/Server Freeze Framework according to at least one embodiment 700 to apply regularization-based layer freezing to specific layers based on their gradients. For instance, bottom layers, such as Layer 1 712 to Layer 2 714 in response to training LeNet on FMNIST 710, Layer 1 722 to Layer 2 724 in response to training VGG on CIFAR-10 720, and Layers 1 to 5 732 in response to training ResNet12 on CIFAR-100 730, bottom layers, such as Layer 1 742 to Layer 2 744 in response to pre-trained LeNet on FMNIST 740, Layer 1 752 in response to pre-trained VGG on CIFAR-10 750, and Layers 1 to 5 and 7 762 in response to pre-trained ResNet12 on CIFAR-100 760, undergo regularization-based layer freezing, while other layers are not frozen locally.

The Local Freezer in Parallel Device/Server Freeze Framework according to at least one embodiment 700 adapt to different architectures and initialization methods. For instance, in response to training VGG11 720 and pre-trained VGG11 750, Local Freezer in Parallel Device/Server Freeze Framework according to at least one embodiment freeze Layer 1 752 as shown in FIG. 7e, while more layers, Layers, e.g., Layers 1-5 732, are frozen locally in response to training ResNet12 on CIFAR-100 730 and Layers 1-5 and 7 762 are frozen in response to pre-trained ResNet12 on CIFAR-100 760, respectively, as shown in FIG. 7c and FIG. 7f. In addition, Parallel Device/Server Freeze Framework according to at least one embodiment adapts to different initialization methods, as demonstrated by the more extensive regularization-based layer freezing decisions when training with pre-trained initialization as shown in FIGS. 7d-f.

### Impact of Hyperparameters

Parallel Device/Server Freeze Framework according to at least one embodiment evaluates the convergence of the global model after aggregation on the server and employs two conditions to determine whether to freeze a layer. These conditions are based on the value of gradient norm and the change of the gradient. As a result, there are two hyperparameters in the Global Freezer that control the global parameter u, which is the coefficient that controls the initial penalty of local regularization is considered.

In general, setting lower thresholds for the gradient norm and the change of the gradient in the Global Freezer results in a more conservative global freezing policy. Similarly, a lower value of the hyper-parameter u in the Local Freezer leads to a more aggressive strategy of local layer freezing. In tests, the hyper-parameters are set separately for random and pre-trained initialization. For random initialization, a threshold value of 0.7 is set for the gradient norm compared to 0.9 for pre-trained initialization. Similarly, a higher coefficient of μ=8 was set for random initialization, while μ=4 was used for pre-trained initialization. This adjustment has advantages because pre-trained initialization starts with more mature parameters than random initialization. The threshold for the change of the gradient was set to 0.001 in both cases. In the tests, the hyper-parameters were found to be generalized across the datasets and models.

### System Overhead

The system overhead in Parallel Device/Server Freeze Framework according to at least one embodiment originates from two modules: the Layer-Wise Regularizer and the Convergence Monitor. The Layer-Wise Regularizer calculates the local layer freezing scheme for the Local Freezer, and the Convergence Monitor analyzes the gradient of layers for the Global Freezer.

The Layer-Wise Regularizer on the device maintains a copy of the gradient changes after several iterations to calculate the layer-wise freezing scheme. A memory cost equivalent to the size of the model parameters is incurred. This is a practical cost as additional memory is used for the model parameters without including the activations. For the computational overhead, generating the local freezing scheme introduces up to 1.5% time overhead to the overall training on the device, which is negligible compared to the overall training time.

The Convergence Monitor on the server also maintains an additional copy of gradient changes after the aggregation of each round to generate global freezing decisions. However, the memory cost and computational overhead are negligible because the memory cost and computational overhead are constrained to the server, which typically is not resource-constrained as the device.

Accordingly, Parallel Device/Server Freeze Framework according to at least one embodiment provides an efficient layer freezing framework which achieves early-stage acceleration and guarantees a high final accuracy. Parallel Device/Server Freeze Framework according to at least one embodiment uses an aggressive regularization-based layer freezing technique to enable early-stage layer freezing on the local devices for the first time and a conservative convergence-based layer freezing on the global server to maintain high final accuracy. The combination of the local-layer freezing and global-layer freezing strategies enables the Parallel Device/Server Freeze Framework according to at least one embodiment to strike a good balance between accuracy and training speed. Parallel Device/Server Freeze Framework according to at least one embodiment achieves similar early stage speedup compared to state-of-the-art early-stage layer freezing approaches while achieving a similar final accuracy compared to vanilla FL and state-of-the-art accuracy-guaranteed layer freezing methods.

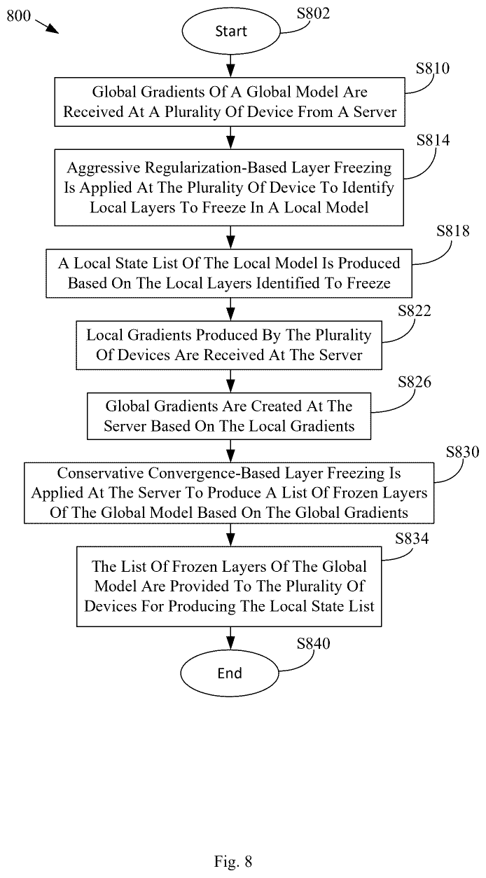

FIG. 8 is a flowchart 800 of a method for providing parallel local learning and synchronized global aggregation to produce an optimal mode according to at least one embodiment.

In FIG. 8, the process begins S802 and global gradients of a global model are received at a plurality of device from a server S810. Referring to FIG. 4, on the device-side 410, Global Gradients of a Global Model 414 are received from the server-side 450 for each round of local training. The Global Gradients of a Global Model 414 received from the server includes an aggregation of Global Gradients of a Global Model 414 generated by the plurality of devices. On a device, for each round of local training, after receiving the Global Gradients of a Global Model 414 from the server 450, Local Trainer 416 iteratively updates the Local State List 418 of the Local Model for several epochs (an epoch is the complete training over the data points). The Local Trainer of the devices then provides the Updated Local Models 420 to the server-side 450.

Aggressive regularization-based layer freezing is applied at the plurality of device to identify local layers to freeze in a local model S814. Referring to FIG. 3, on the device-side 410, Aggressive Regularization-Based Layer Freezing 412 is applied to identify local layers to freeze in a local model to accelerate local learning, even for the initial FL rounds. A two-step process is developed for generating a Local State List of the layers of the Local Model 418 that are frozen, which is referred to as the Local State List. The Local State List 418 is used during training. Local Layer-Wise Regularizer 430 receives the Local Training Gradients 422 from the Local Trainer 416 for generating a Layer-Wise Regularization Penalty Scheme 432. Local Layer-Wise Regularizer 430 analyzes the Local Training Gradients 422 to generate the Layer-Wise Regularization Penalty Scheme 432.

A local state list of the local model is produced based on the local layers identified to freeze S818. Referring to FIG. 3, a Local Freezer 440 combines the Local Regularization Penalty Scheme 432 with the Global State List 454 of the Global Model produced on the server-side 450 by Global Freezer 456 to identify local layers to freeze in a local model. The list of frozen layers received from the Global Freezer 456 is referred to as the Global State List 454. The state of the layers from the Local State List 418 is used by the Local Trainer 416 to freeze the layers in the next training iteration. Local Freezer 440 applies a local freezing matrix as a mask to filter layer parameters.

Local gradients produced by the plurality of devices are received at the server S822. Referring to FIG. 4, the Local Trainer of the devices provides the Updated Local Models 420 to the server-side 450.

Global gradients are created at the server based on the local gradients S826. Referring to FIG. 4, on the server-side 450, after receiving the Local Model Updates 420 from the devices, a Global Aggregator 460 aggregates local gradients using aggregation algorithms, such as FedAvg, to produce Global Gradients 462.

Conservative convergence-based layer freezing is applied at the server to produce a list of frozen layers of the global model based on the global gradients S830. Referring to FIG. 4, Conservative Convergence-Based Layer Freezing 452 is used on the server-side 450 to maintain the final accuracy. Convergence Monitor 470 receives the Global Gradients 462 from Global Aggregator 460. The Convergence Monitor 470 analyzes the convergence behavior of the global model and sends a corresponding Convergence Metric 472 (i.e., the convergence metrics of each layer) to the Global Freezer. The Convergence Metric 472 is also referred to the Convergence Indictor for layers of the Global Model 454. The Global Freezer 456 produces the Global State List 454 that is used by the Global Aggregator 460 to freeze the layers of the global model.

The list of frozen layers of the global model are provided to the plurality of devices for producing the local state list S834. Referring to FIG. 4, the Global State List 454 is also sent to the local devices to be used by the Local Freezer 440.

The aggressive regularization-based layer freezing and conservative convergence-based layer freezing are performed in parallel so that the aggressive regularization-based layer freezing provides device-side layer freezing that accelerates early-stage training of the plurality of devices and the conservative convergence-based layer freezing achieves a global model having high accuracy.

The process then terminates S840.

At least one embodiment of the method includes receiving, at a plurality of devices, global gradients of a global model from a server. Aggressive regularization-based layer freezing is applied at the plurality of devices to the global gradients to identify local layers to freeze in a local model. Based on the local layers identified to freeze, a local state list of the local model is produced. Local gradients produced by the plurality of devices are received at the server. Global gradients are created at the server based on the local gradients. Conservative convergence-based layer freezing is applied at the server to produce a list of frozen layers of the global model based on the global gradients. The list of frozen layers of the global model are provided to the plurality of devices for producing the local state list.

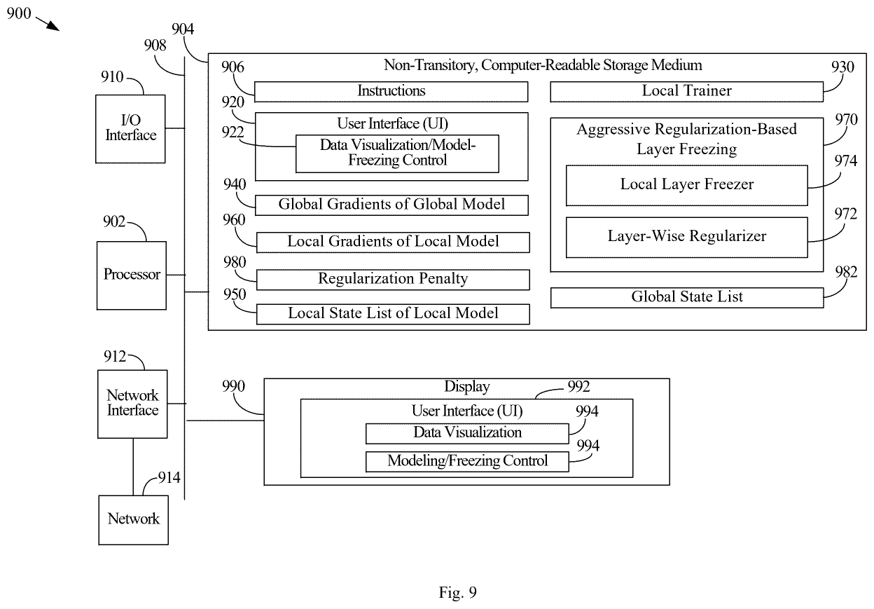

FIG. 9 is a high-level functional block diagram of a processor-based system 900 according to at least one embodiment.

In at least one embodiment, processing circuitry 900 provides aggressive regularization-based layer freezing for Federated Learning (FL). Processing circuitry 900 implements the aggressive regularization-based layer freezing for FL using Processor 902. Processing circuitry 900 also includes a Non-Transitory, Computer-Readable Storage Medium 904 that is used to implement the aggressive regularization-based layer freezing for FL. Non-Transitory, Computer-Readable Storage Medium 904, amongst other things, is encoded with, i.e., stores, Instructions 906, i.e., computer program code, that are executed by Processor 902 causes Processor 902 to perform operations for the aggressive regularization-based layer freezing for FL. Execution of Instructions 906 by Processor 902 represents (at least in part) an application which implements at least a portion of the methods described herein in accordance with one or more embodiments (hereinafter, the noted processes and/or methods).

Processor 902 is electrically coupled to Non-Transitory, Computer-Readable Storage Medium 904 via a Bus 908. Processor 902 is electrically coupled to an Input/Output (I/O) Interface 910 by Bus 908. A Network Interface 912 is also electrically connected to Processor 902 via Bus 908. Network Interface 912 is connected to a Network 914, so that Processor 902 and Non-Transitory, Computer-Readable Storage Medium 904 connect to external elements via Network 914. Processor 902 is configured to execute Instructions 906 encoded in Non-Transitory, Computer-Readable Storage Medium 904 to cause processing circuitry 900 to be usable for performing at least a portion of the processes and/or methods. In one or more embodiments, Processor 902 is a Central Processing Unit (CPU), a multi-processor, a distributed processing system, an Application Specific Integrated Circuit (ASIC), and/or a suitable processing unit.

Processing circuitry 900 includes I/O Interface 910. I/O interface 910 is coupled to external circuitry. In one or more embodiments, I/O Interface 910 includes a keyboard, keypad, mouse, trackball, trackpad, touchscreen, and/or cursor direction keys for communicating information and commands to Processor 902.

Processing circuitry 900 also includes Network Interface 912 coupled to Processor 902. Network Interface 912 allows processing circuitry 900 to communicate with Network 914, to which one or more other computer systems are connected. Network Interface 912 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 900 is configured to receive information through I/O Interface 910. The information received through I/O Interface 910 includes one or more of instructions, data, design rules, libraries of cells, and/or other parameters for processing by Processor 902. The information is transferred to Processor 902 via Bus 908. Processing circuitry 900 is configured to receive information related to a User Interface (UI) through I/O Interface 910. The information is stored in Non-Transitory, Computer-Readable Storage Medium 904 as UI 920, e.g., Data Visualization/Model Freezing Control 922.

In one or more embodiments, one or more Non-Transitory, Computer-Readable Storage Medium 904 having stored thereon Instructions 906 (in compressed or uncompressed form) that may be used to program a computer, processor, or other electronic device) to perform processes or methods described herein. The one or more Non-Transitory, Computer-Readable Storage Medium 904 includes one or more of an electronic storage medium, a magnetic storage medium, an optical storage medium, a quantum storage medium, or the like.

For example, the Non-Transitory, Computer-Readable Storage Medium 904 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 904 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 904 stores Instructions 906 configured to cause Processor 902 to perform at least a portion of the processes and/or methods for implementing aggressive regularization-based layer freezing for FL. In one or more embodiments, Non-Transitory, Computer-Readable Storage Medium 904 also stores information, such as algorithm which facilitates performing at least a portion of the processes and/or methods for implementing the aggressive regularization-based layer freezing for FL. Accordingly, in at least one embodiment, Processor 902 executes Instructions 906 stored on the one or more Non-Transitory, Computer-Readable Storage Medium 904 to implement the aggressive regularization-based layer freezing for FL. Processor 902 implements a Local Trainer 930 that receives Global Gradients of a Global Model 940 from the server-side for each round of local training. The Global Gradients of a Global Model 940 received from the server includes an aggregation of Global Gradients of a Global Model 930 generated by the plurality of devices. For each round of local training, after receiving the Global Gradients of a Global Model 930 from the server, Processor 902 causes Local Trainer 930 to iteratively update the Local State List 950 of the Local Model for several epochs (an epoch is the complete training over the data points). The Processor 902 causes Local Trainer 930 of the devices to provide the updated Local Gradients of the Local Model 960 to the server-side. Processor 902 causes Local Trainer 930 to generate Local Training Gradients of the Local Model 960 based on the Global Gradients of a Global Model 930 and the Local State List 950. Processor 902 implements Aggressive Regularization-Based Layer Freezing 970. Local Training Gradients of the Local Model 960 are provided to the Aggressive Regularization-Based Layer Freezing 970. Processor 902 applies Aggressive Regularization-Based Layer Freezing 412 to identify local layers to freeze in a local model to accelerate local learning, even for the initial FL rounds. Processor 902 uses a two-step process for generating a Local State List of the Local Model 950 that includes updated frozen layers. Processor 902 implements a Layer-Wise Regularizer 972 and a Local Layer Freezer 974. Processor 902 provides the Local Training Gradients of the Local Model 960 from the Local Trainer 930 to the Layer-Wise Regularizer 972 for generating a Layer-Wise Regularization Penalty Scheme 980. Processor 902 causes Local Layer-Wise Regularizer 972 to analyze the Local Training Gradients 960 to generate the Layer-Wise Regularization Penalty Scheme 980. Processor 902 causes Local Freezer 974 to combine the Local Regularization Penalty Scheme 980 with a Global State List 982 of the Global Model received from a server to update the Local State List of the Local Model 950. Processor causes Local Freezer 974 to identify local layers to freeze to produce an updated Local State List of the Local Model 950. Processor 902 provides the updated Local State List of the Local Model 950 to the Local Trainer 930 to generate updated Local Gradients of the Local Model 960 for using the Aggressive Regularization-Based Layer Freezing 970 where layers are determined to be frozen in the next training iteration. Processor 902 causes Local Freezer 974 to apply a local freezing matrix as a mask to filter layer parameters that are frozen. A Display 990 presents a User Interface 992. User Interface 992 presents Data Visualization 994 and Modeling/Freezing Control 994.

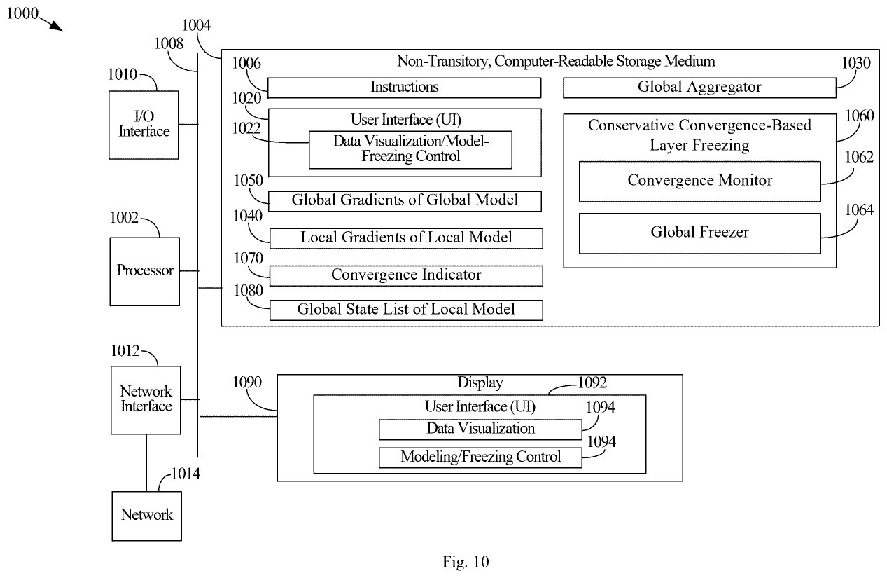

FIG. 10 is a high-level functional block diagram of a processor-based system 1000 according to at least one embodiment.

In at least one embodiment, processing circuitry 1000 provides conservative convergence-based layer freezing to provide high accuracy for a global model for Federated Learning (FL). Processing circuitry 1000 implements the conservative convergence-based layer freezing to provide high accuracy for a global model for FL using Processor 1002. Processing circuitry 1000 also includes a Non-Transitory, Computer-Readable Storage Medium 1004 that is used to implement the conservative convergence-based layer freezing to provide high accuracy for a global model for FL. Non-Transitory, Computer-Readable Storage Medium 1004, amongst other things, is encoded with, i.e., stores, Instructions 1006, i.e., computer program code, that are executed by Processor 1002 causes Processor 1002 to perform operations for the conservative convergence-based layer freezing to provide high accuracy for a global model for FL. Execution of Instructions 1006 by Processor 1002 represents (at least in part) an application which implements at least a portion of the methods described herein in accordance with one or more embodiments (hereinafter, the noted processes and/or methods).

Processor 1002 is electrically coupled to Non-Transitory, Computer-Readable Storage Medium 1004 via a Bus 1008. Processor 1002 is electrically coupled to an Input/Output (I/O) Interface 1010 by Bus 1008. A Network Interface 1012 is also electrically connected to Processor 1002 via Bus 1008. Network Interface 1012 is connected to a Network 1014, so that Processor 1002 and Non-Transitory, Computer-Readable Storage Medium 1004 connect to external elements via Network 1014. Processor 1002 is configured to execute Instructions 1006 encoded in Non-Transitory, Computer-Readable Storage Medium 1004 to cause processing circuitry 1000 to be usable for performing at least a portion of the processes and/or methods. In one or more embodiments, Processor 1002 is a Central Processing Unit (CPU), a multi-processor, a distributed processing system, an Application Specific Integrated Circuit (ASIC), and/or a suitable processing unit.

Processing circuitry 1000 includes I/O Interface 1010. I/O interface 1010 is coupled to external circuitry. In one or more embodiments, I/O Interface 1010 includes a keyboard, keypad, mouse, trackball, trackpad, touchscreen, and/or cursor direction keys for communicating information and commands to Processor 1002.

Processing circuitry 1000 also includes Network Interface 1012 coupled to Processor 1002. Network Interface 1012 allows processing circuitry 1000 to communicate with Network 1014, to which one or more other computer systems are connected. Network Interface 1012 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 1000 is configured to receive information through I/O Interface 1010. The information received through I/O Interface 1010 includes one or more of instructions, data, design rules, libraries of cells, and/or other parameters for processing by Processor 1002. The information is transferred to Processor 1002 via Bus 1008. Processing circuitry 1000 is configured to receive information related to a User Interface (UI) through I/O Interface 1010. The information is stored in Non-Transitory, Computer-Readable Storage Medium 1004 as UI 1020, e.g., Data Visualization/Model Freezing Control 1022.

In one or more embodiments, one or more Non-Transitory, Computer-Readable Storage Medium 1004 having stored thereon Instructions 1006 (in compressed or uncompressed form) that may be used to program a computer, processor, or other electronic device) to perform processes or methods described herein. The one or more Non-Transitory, Computer-Readable Storage Medium 1004 includes one or more of an electronic storage medium, a magnetic storage medium, an optical storage medium, a quantum storage medium, or the like.

For example, the Non-Transitory, Computer-Readable Storage Medium 1004 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 1004 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 1004 stores Instructions 1006 configured to cause Processor 1002 to perform at least a portion of the processes and/or methods for implementing conservative convergence-based layer freezing to provide high accuracy for a global model for FL. In one or more embodiments, Non-Transitory, Computer-Readable Storage Medium 1004 also stores information, such as algorithm which facilitates performing at least a portion of the processes and/or methods for implementing conservative convergence-based layer freezing to provide high accuracy for a global model for FL. Accordingly, in at least one embodiment, Processor 1002 executes Instructions 1006 stored on the one or more Non-Transitory, Computer-Readable Storage Medium 1004 to implement the conservative convergence-based layer freezing to provide high accuracy for a global model for FL. Processor 1002 implements a Global Aggregator 1030 that receives Local Gradients of a Local Model 1040 from the devices and aggregates the Local Gradients of the Local Model 1040 using aggregation algorithms, such as FedAvg, to produce Global Gradients 1050. Processor 1002 implements Conservative Convergence-Based Layer Freezing 1060 on the server-side to maintain the final accuracy. For the Conservative Convergence-Based Layer Freezing 1060, Processor implements a Convergence Monitor 1062. Processor provides the Global Gradients 1050 from Global Aggregator 1030. Processor 1002 causes Convergence Monitor 1062 to analyze the convergence behavior of the Global Gradients of the Global Model 1050. Processor implements a Global Freezer 1064. Processor 1002 causes Convergence Monitor 1062 to send a corresponding Convergence Indicator 1070 (i.e., the convergence metrics of each layer) to the Global Freezer 1064. Processor 1002 causes the Global Freezer 1064 to produce a Global State List 1080 that is used by the Global Aggregator 1030 to freeze the layers of the global model. Processor also causes the Global State List 1080 to be sent to the local devices for updating a local state list of a local model. A Display 1090 presents a User Interface 1092. User Interface 1092 presents Data Visualization 1094 and Modeling/Freezing Control 1094.

Embodiments described herein provide a method that provides one or more advantages. For example, a Parallel Device/Server Freeze Framework for FL combines features of both early-stage acceleration and accuracy-guaranteed layer freezing. The Parallel Device/Server Freeze Framework for FL applies a regularization-based layer freezing approach on the device to apply early-stage layer freezing during the initial stages of local training for achieving improved speed in training. The Parallel Device/Server Freeze Framework for FL also applies a convergence-based layer freezing approach to ensure that a high final accuracy of a global model is achieved.

[1] An aspect of this description is directed to a method that includes receiving, at a plurality of devices, global gradients of a global model from a server, applying, at the plurality of devices, aggressive regularization-based layer freezing to the global gradients to identify local layers to freeze in a local model, based on the local layers identified to freeze, producing a local state list of the local model, receiving, at the server, local gradients produced by the plurality of devices, creating, at the server, global gradients based on the local gradients, applying, at the server, conservative convergence-based layer freezing to produce a list of frozen layers of the global model based on the global gradients, and providing the list of frozen layers of the global model to the plurality of devices for producing the local state list.

[2] The method described in [1], wherein the receiving, at the plurality of devices, the global gradients of the global model from the server includes an aggregation of local gradients of the local models generated by the plurality of devices.

[3] The method described in any of [1] to [2], wherein the applying the aggressive regularization-based layer freezing to identify the local layers to freeze in the local model includes receiving local training gradients from a Local Trainer, the Local Trainer generating the local training gradients based on the global gradients of the global model received from the server and local state list, processing the local training gradients to generate a layer-wise regularization penalty, and combining the layer-wise regularization penalty with the list of frozen layers of the global model to produce the local state list.

[4] The method described in any of [1] to [3], wherein the applying, at the server, the conservative convergence-based layer freezing to produce the list of frozen layers of the global model includes receiving updated local gradients of the local model from the plurality of devices, aggregating the updated local gradients to produce updated global gradients, processing the updated global gradients to determine a convergence metric indicating converged layers of the global model, and based on the convergence metric, freezing the converged layers of the global model to produce the list of frozen layers of the global model.

[5] The method described in any of [1] to [4], wherein the freezing the converged layers of the global model to produce the global gradients includes producing a global state list of the global model.

[6] The method described in any of [1] to [5], wherein the applying, at the plurality of devices, the aggressive regularization-based layer freezing to identify the local layers to freeze in the local model and the applying, at the server, conservative convergence-based layer freezing to produce the list of frozen layers of the global model based on the global gradients provide server-side layer freezing are performed in parallel so that the aggressive regularization-based layer freezing provides device-side layer freezing that accelerates early-stage training of the plurality of devices and the conservative convergence-based layer freezing achieves the global model having high accuracy.

[7] method described in any of [1] to [5], wherein the applying, at the plurality of devices, the aggressive regularization-based layer freezing to identify the local layers to freeze in the local model includes applying a local freezing matrix to the local state list as a mask to filter layer parameters.

[8] An aspect of this description is directed to a device configured to receive global gradients of a global model from a server, generate local training gradients based on the global gradients of the global model received from the server and a local state list, apply aggressive regularization-based layer freezing to the local training gradients to identify local layers to freeze in a local model, and based on the local layers identified to freeze, produce the local state list of the local model.

[9] The device described in [8], wherein the global gradients of the global model received from the server includes an aggregation of local gradients of the local model generated by a plurality of devices.

[10] The device described in any of [8] to [9] further configured to apply the aggressive regularization-based layer freezing to the identify local layers to freeze in the local model by processing the local training gradients to generate a layer-wise regularization penalty, and combining the layer-wise regularization penalty with a list of frozen layers of the global model received from the server to produce the local state list.

[11] The device described in any of [8] to [10] further configured to generate the layer-wise regularization penalty by adaptively adjusting a length of iterations for the local layers by calculating an average value of the local gradients and adjusting the layer-wise regularization penalty based on a change in the average value of the local gradients.

[12] The device described in any of [8] to [11] further configured to, in response to the average value of the local gradients decreasing, decrease the layer-wise regularization penalty on the local layers, or in response to the average value of the local gradients not decreasing, increasing the layer-wise regularization penalty on the local layers.

[13] The device described in any of [8] to [12] further configured to apply the aggressive regularization-based layer freezing to identify the local layers to freeze in the local model to accelerate early-stage training of a plurality of devices.

[14] The device described in any of [8] to [13] further configured to apply the aggressive regularization-based layer freezing to identify the local layers to freeze in the local model by applying a local freezing matrix to the global model as a mask to filter layer parameters in the local state list.

[15] An aspect of this description is directed to a non-transitory computer-readable media having computer-readable instructions stored thereon, which when executed perform operations to receive local gradients from a plurality of devices, aggregate the local gradients from the plurality of devices to produce updated global gradients, provide the updated global gradients to the plurality of devices, apply conservative convergence-based layer freezing to the updated global gradients to produce a list of frozen layers of a global model, and provide the list of frozen layers of the global model to the plurality of devices for producing a local state list.

[16] The non-transitory computer-readable media described in [15] further configured to apply, the conservative convergence-based layer freezing to produce the list of frozen layers of the global model by processing the updated global gradients to determine a convergence metric indicating converged layers of the global model, and based on the convergence metric, freezing the converged layers of the global model to produce the list of frozen layers of the global model.

[17] The non-transitory computer-readable media described in any of [15] to [16] further configured to process the updated global gradients to determine the convergence metric indicating converged layers of the global model by analyzing a convergence behavior of the global model to generate the convergence metric.

[18] The non-transitory computer-readable media described in any of [15] to [17] further configured to analyze the convergence behavior of the global model by determining an average norm of the global gradients for each layer, and, in response to determining one of the layers in the global model is frozen, parameters of the one of the layers are not updated, or in response to determining one of the layers in the global model is not frozen, the one of the layers is updated.

The non-transitory computer-readable media described in any of [15] to [18] further configured to determine the average norm of the global gradients by determining a moving average of the global gradients.

The non-transitory computer-readable media described in any of [15] to [19] further configured to process the updated global gradients to determine the convergence metric indicating converged layers of the global model by analyzing parameters of a layer to determine whether a layer has converged.

Separate instances of these programs can be executed on or distributed across any number of separate computer systems. Thus, although certain operations have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method, comprising:
receiving, at a plurality of devices, global gradients of a global model from a server;
applying, at the plurality of devices, aggressive regularization-based layer freezing to the global gradients to identify local layers to freeze in a local model;
based on the local layers identified to freeze, producing a local state list of the local model;
receiving, at the server, local gradients produced by the plurality of devices;
creating, at the server, global gradients based on the local gradients;
applying, at the server, conservative convergence-based layer freezing to produce a list of frozen layers of the global model based on the global gradients; and
providing the list of frozen layers of the global model to the plurality of devices for producing the local state list.

2. The method of claim 1, wherein the receiving, at the plurality of devices, the global gradients of the global model from the server includes an aggregation of local gradients of the local model generated by the plurality of devices.

3. The method of claim 1, wherein the applying the aggressive regularization-based layer freezing to identify the local layers to freeze in the local model includes:
receiving local training gradients from a Local Trainer, the Local Trainer generating the local training gradients based on the global gradients of the global model received from the server and local state list;
processing the local training gradients to generate a layer-wise regularization penalty; and
combining the layer-wise regularization penalty with the list of frozen layers of the global model to produce the local state list.

4. The method of claim 1, wherein the applying, at the server, the conservative convergence-based layer freezing to produce the list of frozen layers of the global model includes:
receiving updated local gradients of the local model from the plurality of devices;
aggregating the updated local gradients to produce updated global gradients;
processing the updated global gradients to determine a convergence metric indicating converged layers of the global model; and
based on the convergence metric, freezing the converged layers of the global model to produce the list of frozen layers of the global model.

5. The method of claim 1, wherein the freezing the converged layers of the global model to produce the global gradients includes producing a global state list of the global model.

6. The method of claim 1, wherein the applying, at the plurality of devices, the aggressive regularization-based layer freezing to identify the local layers to freeze in the local model and the applying, at the server, conservative convergence-based layer freezing to produce the list of frozen layers of the global model based on the global gradients provide server-side layer freezing are performed in parallel so that the aggressive regularization-based layer freezing provides device-side layer freezing that accelerates early-stage training of the plurality of devices and the conservative convergence-based layer freezing achieves the global model having high accuracy.

7. The method of claim 1, wherein the applying, at the plurality of devices, the aggressive regularization-based layer freezing to identify the local layers to freeze in the local model includes applying a local freezing matrix to the local state list as a mask to filter layer parameters.

8. A device configured to:
receive global gradients of a global model from a server;
generating local training gradients based on the global gradients of the global model received from the server and a local state list;
apply aggressive regularization-based layer freezing to the local training gradients to identify local layers to freeze in a local model; and
based on the local layers identified to freeze, produce the local state list of the local model.

9. The device of claim 8, wherein the global gradients of the global model received from the server includes an aggregation of local gradients of the local model generated by a plurality of devices.

10. The device of claim 8 further configured to apply the aggressive regularization-based layer freezing to identify the local layers to freeze in the local model by:
processing the local training gradients to generate a layer-wise regularization penalty; and
combining the layer-wise regularization penalty with a list of frozen layers of the global model received from the server to produce the local state list.

11. The device of claim 10 further configured to generate the layer-wise regularization penalty by adaptively adjusting a length of iterations for the local layers by calculating an average value of the local gradients and adjusting the layer-wise regularization penalty based on a change in the average value of the local gradients.

12. The device of claim 11 further configured to, in response to the average value of the local gradients decreasing, decrease the layer-wise regularization penalty on the local layers, or in response to the average value of the local gradients not decreasing, increasing the layer-wise regularization penalty on the local layers.

13. The device of claim 8 further configured to apply the aggressive regularization-based layer freezing to identify the local layers to freeze in the local model to accelerate early-stage training of a plurality of devices.

14. The device of claim 8 further configured to apply the aggressive regularization-based layer freezing to identify the local layers to freeze in the local model by applying a local freezing matrix to the global model as a mask to filter layer parameters in the local state list.

15. A device configured to:
receive local gradients from a plurality of devices;
aggregate the local gradients from the plurality of devices to produce updated global gradients;
provide the updated global gradients to the plurality of devices;
apply conservative convergence-based layer freezing to the updated global gradients to produce a list of frozen layers of a global model; and
provide the list of frozen layers of the global model to the plurality of devices for producing a local state list.

16. The device of claim 15 further configured to apply, the conservative convergence-based layer freezing to produce the list of frozen layers of the global model by:
processing the updated global gradients to determine a convergence metric indicating converged layers of the global model; and
based on the convergence metric, freezing the converged layers of the global model to produce the list of frozen layers of the global model.

17. The device of claim 16 further configured to process the updated global gradients to determine the convergence metric indicating converged layers of the global model by analyzing a convergence behavior of the global model to generate the convergence metric.

18. The device of claim 17 further configured to analyze the convergence behavior of the global model by determining an average norm of global gradients for each layer, and, in response to determining one or more layers in the global model are frozen, parameters of the one or more layers are not updated, or in response to determining one or more layers in the global model is not frozen, the one or more layers are updated.

19. The device of claim 18 further configured to determine the average norm of the global gradients by determining a moving average of the global gradients.

20. The device of claim 16 further configured to process the updated global gradients to determine the convergence metric indicating converged layers of the global model by analyzing parameters of local layers to determine whether one or more of the local layers have converged.
